(19) United States
(12) Patent Application Publication
(10) Pub. No.: US 2025/0380785 A1
(43) Pub. Date: Dec. 18, 2025

(54) AN APPLIANCE

(71) Applicant: Dyson Technology Limited, Malmesbury, Wiltshire (GB)

(72) Inventors: Moon Hyo KANG, Swindon (GB); Christos KATSIMPOULAS, Bristol (GB)

(21) Appl. No.: 19/130,175

(22) PCT Filed: Nov. 8, 2023
(86) PCT No.: PCT/IB2023/061268

§ 371 Date: May 15, 2025

(30) Foreign Application Priority Data
Nov. 18, 2022 (GB) 2217269.6

(51) Int. Cl. A45D 20/12

(52) U.S. Cl. CPC A45D 20/122

(57) ABSTRACT

An appliance that includes a main unit to which one of a plurality of attachments is attachable. The appliance also includes a capacitance sensor, and a control module that is able to determine which of the plurality of attachments is attached to the main unit based on data output by the capacitance sensor.

### FIELD OF THE INVENTION

The present invention relates to an appliance, such as a haircare appliance.

### BACKGROUND OF THE INVENTION

Haircare appliances are generally used to treat or style hair, and some haircare appliances may treat or style hair using airflow and/or heat. Haircare appliances may be used to treat or style hair in a number of different ways, and some haircare appliances include different attachments to provide different treatment or styling functionality.

### SUMMARY OF THE INVENTION

According to a first aspect of the present invention there is provided an appliance comprising: a main unit to which one of a plurality of attachments is attachable; a capacitance sensor; and a control module operable to determine which of the plurality of attachments is attached to the main unit based on data output by the capacitance sensor.

By employing a capacitance sensor, the control module may enable determination of which of the plurality of attachments is attached to the main unit absent the need for any mechanical switches, or optical paths which may require precise alignment and/or movable parts which could be prone to failure. Furthermore, employing a capacitance sensor to determine which of the plurality of attachments is attached to the main unit may provide greater flexibility in choice for further sensing mechanisms that detect other features, for example a property of an object external to the appliance, when compared to an arrangement that utilises an optical sensing method for determining which attachment is attached to the main unit. In particular, use of an optical sensing method to determine which of the attachments is attached to the main unit may, in some circumstances, preclude use of another optical sensing method to determine a property of an object external to the appliance, for example due to optical interference between the two sensing methods. Use of a capacitance sensor for determining which attachment is attached to the main unit may not suffer from such interference, and may enable an optical sensing method to be utilised for determining a property of an object external to the appliance.

The appliance may be a haircare appliance.

The appliance may comprise an electric component and the control module may be operable to control the electric component in response to the determination. The control module may therefore be able to control the electric component differently for different attachments. This then has the benefit that operation of the appliance may be controlled automatically on the basis of the attachment that is in use. The control module may be operable to control the input power to the electric component in response to the determination.

The electric component may be an electric motor or a heater, and the control module may be operable to control a speed of the electric motor or a temperature of the heater in response to the determination. The performance of the appliance may be improved by operating the electric motor at different speeds and/or by operating the heater at different temperatures based on the attachment that is in use. For example, the appliance may be a haircare appliance, the electric motor may be used to generate an airflow, and the heater may be used to heat the airflow. Different attachments may then provide better drying or styling results at different flow rates and/or at different heat settings.

The appliance may comprise an airflow generator for drawing an airflow through the appliance, and the control module may be operable to control a characteristic of the airflow in response to the determination. Different attachments may deliver better results for different airflows. For example, the appliance may be a haircare appliance and the attachments may comprise a diffuser and a concentrator. The diffuser may deliver better results when the airflow has lower flow rate. This is because the hair is moved less by the airflow and thus curls are better defined. By contrast, a concentrator may deliver better results when the airflow has a higher flow rate. For example, by employing a higher flow rate, drying and/or styling of the hair may be achieved more rapidly.

The control module may be operable to control one or more of a flow rate and a temperature of the airflow. As above, different attachments may deliver better results for different flow rates. Additionally or alternatively, different attachments may deliver better results for different temperatures. For example, the appliance may be a haircare appliance and at least one of the attachments may provide better styling results at a lower heat setting, and at least one of the attachments may provide better styling results at a higher heat setting. By controlling the flow rate and/or the temperature of the airflow in response to the attachment in use, better overall results may be achieved.

The appliance may be a haircare appliance comprising a plurality of flow and heat settings, and the control module may be operable to select one of the settings based on the determination. As above, different attachments may deliver better results for different flow and/or heat settings. Accordingly, by selecting one of the plurality of settings based on the attachment in use, better drying and/or styling results may be achieved.

The appliance may comprise the plurality of attachments, and each of the plurality of attachments may be configured to cause a different capacitive response the capacitance sensor, for example with the capacitance sensor measuring a different capacitive response. This may enable determination of which different capacitive response. attachment is attached to the main unit based on the data output by the capacitance sensor in the manner described above.

The main unit may comprise a first electrode, and each of the plurality of attachments may comprise a respective second electrode, each second electrode different to each other second electrode. By providing each attachment with a different second electrode, each attachment may provide a different capacitive response to the capacitance sensor, for example when the second electrode overlies the first electrode, enabling the control module to distinguish between different attachments when attached to the main unit.

Each second electrode may comprise a different cross-sectional area to each other second electrode. This may provide a relatively simple way to provide a different capacitive response to the capacitance sensor between different attachments.

A first one of the plurality of attachments may comprise a first number of second electrodes, and a second one of the plurality of attachments may comprise a second number of second electrodes different to the first number of second electrodes. This may provide a relatively simple way to provide a different capacitive response to the capacitance sensor between different attachments.

The data output by the capacitance sensor may be indicative of a capacitance value measured when the respective one of the plurality of attachments is attached to the main unit. Providing data indicative of the measured capacitance value may provide relatively straightforward numerical values to compare to determine which attachment is attached to the main unit.

The first electrode may comprise a plurality of first electrodes, and the data output by the capacitance sensor may be indicative of a number of the plurality of first electrodes that overlap with the second electrode of the respective one of the plurality of attachments when attached to the main unit. This may provide a relatively straightforward metric by which to compare and determine which of the plurality of attachments is attached to the main unit. For example, for a given array of first electrodes, second electrodes of different sizes may overlap different numbers of the first electrodes, thereby providing a different capacitive response.

The capacitance sensor may comprise a multi-channel capacitance sensor, with each channel corresponding to a different one of the plurality of first electrodes. In this way, differing numbers of channels may provide a change in capacitive response depending on a degree of overlap of the second electrode with the plurality of first electrodes, and counting the number of channels on which a change in capacitive response is present may provide a simple way to compare and determine which of the plurality of attachments is attached to the main unit.

Each second electrode may be sized such that the second electrode overlaps a discrete, for example a non-empty, subset of the plurality of first electrodes. At least some of the second electrodes may be sized such that, depending on a rotational orientation of the respective attachment to the main unit, the second electrode overlaps a different subset of the plurality of first electrodes. At least some of the second electrodes may be sized such that, depending on a rotational orientation of the respective attachment to the main unit, the second electrode overlaps a different cardinality of subset of the plurality of first electrodes. For example, each second electrode may be positionable relative to the first electrode such that the second electrode overlaps a first cardinality of subset of the plurality of first electrodes or a second cardinality of subset of the plurality of first electrodes.

The second electrode may comprise a plurality of second electrodes. Use of a plurality of second electrodes in combination with a plurality of first electrodes may provide for a greater combination of possible overlapping patterns of electrodes, which may allow for distinguishing between a greater number of attachments than an embodiment where a single second electrode is utilised alongside a plurality of first electrodes.

The plurality of first electrodes may be arranged in a substantially annular array, each second electrode may be arcuate in form.

The plurality of first electrodes and each second electrode may be configured such that the data output by the capacitance sensor is dependent on a rotational orientation of the attachment to the main unit. This may enable determination of a rotational orientation of the attachment to the main unit.

The plurality of first electrodes and each second electrode may be configured such that the data output by the capacitance sensor is constant for a given attachment irrespective of rotational orientation of the attachment to the main unit.

For example, for a given attachment, the capacitive response measured by the capacitance sensor may be constant irrespective of rotational orientation of the attachment to the main unit. This may ensure correct determination of which attachment is attached to the main unit irrespective of rotational orientation of the attachment to the main unit.

The main unit may comprise an interface portion configured to interface with a main unit of the haircare appliance, the interface portion comprising an electrode layer wherein the electrode layer is exposed at the interface portion.

The main unit may comprise a first electrode, and a first dielectric portion overlying the first electrode, each of the plurality of attachments may comprise a respective second electrode, and a respective second dielectric portion overlying the second electrode. Provision of such dielectric portions may inhibit contact of the electrodes by a user in use.

Each second dielectric portion may be different to each other second dielectric portion. This may provide a relatively straightforward mechanism by which different capacitive responses can be provided by different attachments, for example whilst keeping the main body the same between attachments

Each second dielectric portion may comprise a different thickness to each other second dielectric portion. This may provide a relatively simple mechanism for providing different capacitive responses between different attachments.

The first and second dielectric portions may be formed of the same dielectric material.

The first dielectric portion may be unevenly distributed across the first electrode.

Each of the plurality of attachments may comprise a respective second electrode, and a respective second dielectric portion overlying the second electrode, and each second dielectric portion may be different to each other second dielectric portion.

A capacitance sensor can detect without signal interference such as radio frequency or magnetic induction with other electrical components in the appliances. It only detects the capacitance value between two or more electrodes arranged with dielectric layer.

The main unit may comprise a drive electrode and a receiver electrode, and each of the plurality of attachments may comprise a respective second electrode, each second electrode different to each other second electrode. In such a manner, each second electrode may affect a magnetic field present between the drive electrode and the receiver electrode and as each second electrode is different, the second electrodes, and hence the attachments, may provide different capacitive responses when attached to the main body, Such an arrangement may provide greater stability than, for example, an arrangement where physically opposing electrodes are present on the main unit and the attachment, where spikes in capacitance measurements due to speed of connection of the attachment to the main unit can occur.

Each second electrode may comprise a different cross-sectional area and/or thickness to each other second electrode.

The appliance may comprise an emitter configured to emit optical radiation, an optical sensor configured to receive reflected optical radiation from an object external to the appliance, and a further control module configured to determine a property of the object based on further data output by the optical sensor. This may enable the appliance to both determine which attachment is attached to the main unit, alongside a property of an object external to the appliance. For example, the property of the object may comprise any of a presence or absence of the object, a type of the object, a distance of the object from the main unit, a distance of the object from the attachment, a temperature of the object, and a moisture content of the object. The emitter and the optical sensor may comprise a time-of-flight sensor. The further control module and the control module may be the same control module.

The appliance may comprise an electric component and the further control module may be operable to control the electric component in response to the determination of the property of the object. The further control module may therefore be able to control the electric component differently for different properties of external objects.

The electric component may be an electric motor or a heater, and the further control module may be operable to control a speed of the electric motor or a temperature of the heater in response to the determination of the property of the object.

The appliance may comprise an airflow generator for drawing an airflow through the appliance, and the further control module may be operable to control a characteristic of the airflow in response to the determination of the property of the object.

The further control module may be operable to control one or more of a flow rate and a temperature of the airflow.

The appliance may be a haircare appliance comprising a plurality of flow and heat settings, and the further control module may be operable to select one of the settings based on the determination of the property of the object.

At least some of the plurality of attachments may comprise a portion of optically transparent material, the emitter may be configured to emit optical radiation toward a respective portion of optically transparent material of one of the plurality of attachments when attached to the main unit, and the optical sensor may be configured to receive reflected optical radiation from the object external to the appliance through the respective portion of optically transparent material.

The main unit may comprise a barrel section having a central bore, the plurality of attachments are attachable to an end of the barrel section, and at least one of the emitter and the optical sensor are located within the bore.

This may provide a direct, unobstructed path between the emitter and the attachment, and/or between the attachment and the optical sensor. Additionally, emissions may be better confined within the appliance. Furthermore, for appliances that already have an existing bore, the emitter and/or optical sensor may be incorporated without increasing the overall size of the appliance.

The first electrode may be substantially annular about an end of the bore. The plurality of first electrodes may be arranged in a substantially annular array about an end of the bore.

According to a second aspect of the present invention there is provided an attachment for a haircare appliance, the attachment comprising an interface portion configured to interface with a main unit of the haircare appliance, an electrode layer located at the interface portion, and a dielectric layer overlying the electrode layer such that the dielectric layer is exposed at the interface portion.

Optional features of aspects of the present invention may be equally applied to other aspects of the present invention, where appropriate.

### BRIEF DESCRIPTION OF THE DRAWINGS

FIG. 1 is a schematic view of a first embodiment of a haircare appliance;

FIG. 2 is a schematic sectional view of a main unit of the haircare appliance of FIG. 1;

FIG. 3 is a schematic rear view of the main unit of FIG. 2;

FIG. 4 is a schematic illustration of an electrode array of the haircare appliance of FIG. 1;

FIG. 5 is a schematic illustration of attachments of the haircare appliance of FIG. 1;

FIG. 6 is a schematic illustration of positioning of electrodes of the attachments of FIG. 5 in relation to the electrode array of FIG. 4;

FIG. 7 is a schematic illustration of the haircare appliance of FIG. 1 when an attachment is attached to the main unit;

FIG. 8 is a schematic view of a second embodiment of a haircare appliance;

FIG. 9 is a schematic view of positioning of electrodes of the haircare appliance of FIG. 8;

FIG. 10 is a schematic illustration of alternative embodiments of attachments for the haircare appliance of FIG. 9;

FIG. 11 is a schematic illustration of capacitance readings for attachments; and

FIG. 12 is a schematic view of a third embodiment of a haircare appliance.

### DETAILED DESCRIPTION OF THE INVENTION

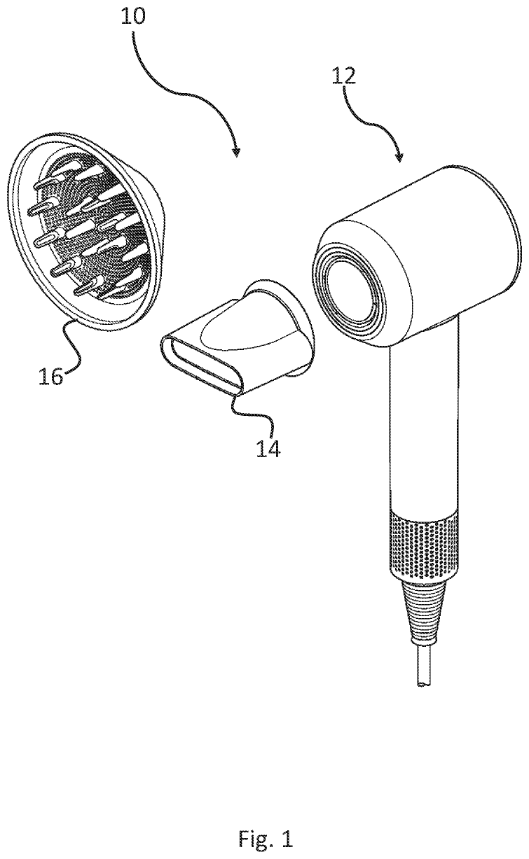

A first embodiment of an appliance 10, in the form of a haircare appliance, is illustrated schematically in FIGS. 1-3. The appliance 10 comprises a main unit 12, and a plurality of attachments 14,16, each of which is attachable to the main unit 12. Here the attachments 14, 16 comprise a concentrator 14 and a diffuser 16, although it will be appreciated that other types of attachment are envisaged.

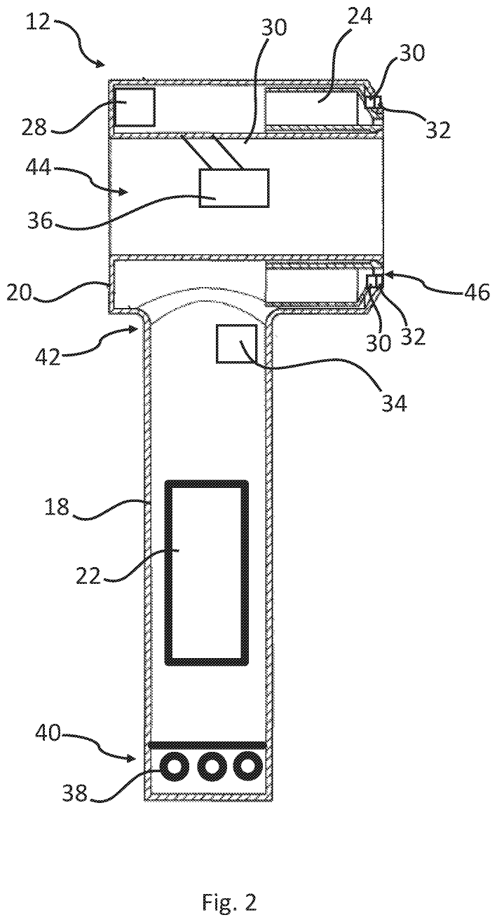

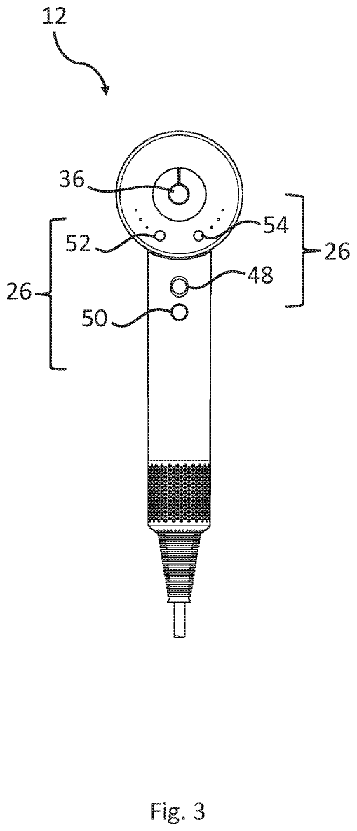

The main unit 12 is shown schematically in isolation in FIGS. 2 and 3, and comprises a handle portion 18, a head portion 20, an airflow generator 22, a heater 24, user controls 26, a control module 28, a plurality of first electrodes 30, a first dielectric layer 32, a capacitance sensor 34, and a time-of-flight sensor 36. It will be appreciated that in some examples the capacitance sensor 34 can be integrated with the control module 28, for example as a single unit.

The handle portion 18 is generally cylindrical and hollow in form, and houses the airflow generator 22. The handle portion 18 has an air inlet 38 in the form of a plurality of perforations at a first end 40 of the handle portion 18.

The head portion 20 is generally cylindrical and hollow in form, and is disposed at a second end 42 of the handle portion 18, with a central axis of the head portion 20 orthogonal to a central axis of the handle portion 18 such that the main unit 12 is generally T-shaped in form. The head portion 20 houses the heater 24. The head portion 20 comprises a bore 44 through which air is entrained, and an air outlet 46. The air outlet 46 is generally annular in form about a periphery of the bore 44. The head portion 20 further comprises an annular magnet (not shown) for releasably connecting the handle unit 12 to the attachments 14,16. The annular magnet extends annularly about the air outlet 46.

The user controls 26 are provided on both the handle portion 18 and the head portion 20, and comprise a first button 48 or slider to power on and off the appliance 10, a second button 50 to momentarily power off the heater 24 such that the appliance 10 delivers a cold shot of air, a third button 52 to control the flow rate of the airflow, and a fourth button 54 to control the temperature of the airflow.

The control module 28 is responsible for controlling the airflow generator 22 and the heater 24 in response to inputs from the user controls 26. For example, in response to inputs from the user controls 26, the control module 28 may power on and off the airflow generator 22 and/or the heater 24. Additionally, the control module 28 may control the power or speed of the airflow generator 22 in order to vary the flow rate of the airflow. For example, repeatedly pressing the third button 52 may cause the control module 28 to cycle through different flow rates (e.g., low, medium and high). Similarly, the control module 28 may control the power of the heater 24 in order to vary the temperature of the airflow. For example, repeatedly pressing the fourth button 54 may cause the control module 28 to cycle through different temperature settings (e.g., cold, warm, hot).

The control module 28 further controls the airflow generator 22 and the heater 24 in response to inputs from the capacitance sensor 34 and the time-of-flight sensor 36, as will be discussed in more detail hereafter.

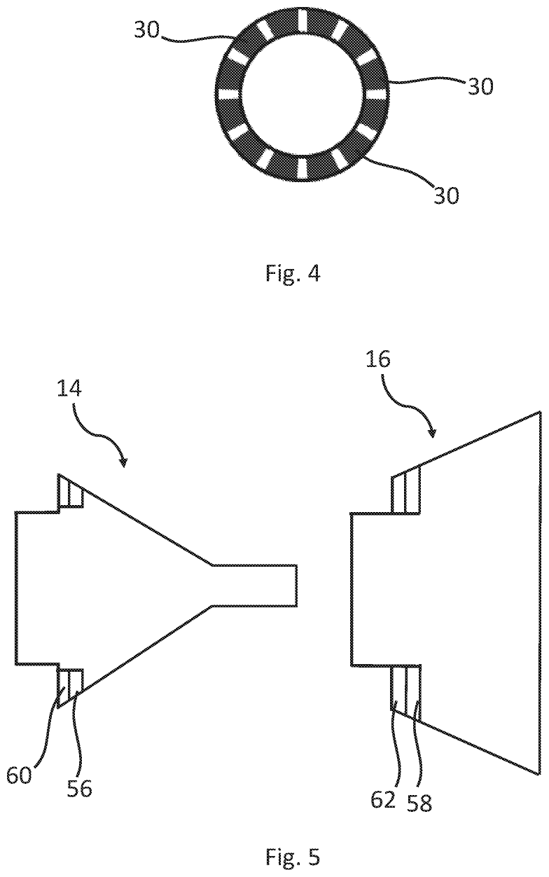

The plurality of first electrodes 30 comprises twelve electrodes evenly spaced in an annular array, as illustrated schematically in FIG. 4. The plurality of first electrodes 30 are located within the head portion 20 such that the plurality of first electrodes 30 extend annularly about the air outlet 46. The plurality of first electrodes 30 each have a substantially similar cross-sectional area, and are formed of an appropriate conductive material such as copper. In other examples a magnetic material used to connect the main unit 12 to the attachments 14,16 may be located in the main unit, and may be used to also define the plurality of first electrodes 30.

The first dielectric layer 32 is generally annular in form, and overlies the plurality of first electrodes 30, such that the plurality of first electrodes 30 are not exposed to an environment external to the head portion 20. An exemplary material for the first dielectric material 32 is a polyimide material.

The capacitance sensor 34 comprises a twelve-channel capacitance sensor, and is located within the handle portion 18 at the second end 42. The capacitance sensor 34 is electrically connected to the plurality of first electrodes 30 by electrical cabling, which is not shown for sake of clarity.

The time-of-flight (TOF) sensor 36 is located within the bore 44 along a central axis of the bore 44, such that the time-of-flight sensor 36 is located radially inwardly of the sensor assembly 56. The TOF sensor 36 is an integrated package or all-in-one system that comprises an emitter, a receiver, and a processor. The emitter emits emissions, which in this example are photons of electromagnetic radiation. The receiver then receives reflected emissions, which have been reflected and returned to the TOF sensor 36. The processor then determines time differences between emitting and receiving the emissions and from this calculates distances between the TOF sensor 36 and targets responsible for the reflected emissions. The processor then outputs this distance data to the control module 28.

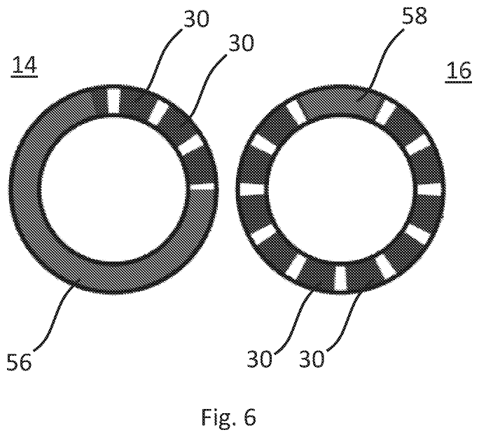

Each of the concentrator and diffuser attachments 14, 16 is formed of an optically transparent material, yet also comprises a respective second electrode 56,58 and a respective second dielectric material 60,62, as illustrated schematically in FIGS. 5 and 6. Each second electrode 56,58 is arcuate in form, and is positioned on the respective concentrator and diffuser attachment 14,16 such that they overlie at least some of the plurality of first electrodes 30 when the attachment 14,16 is attached to the head portion 20 of the main unit 12, irrespective of the rotational orientation of the attachment 14,16 relative to the head portion 20. As seen in FIG. 6, the arcuate extent of each of the second electrodes 56,58 is different, such that each second electrode 56,58 has a different cross-sectional area. The second electrodes 56,58 are formed of an appropriate conductive material such as copper. The second dielectric materials 60,62 overlie the respective second electrodes 56,58, such that the second electrodes 56,58 are not exposed to an environment external to the respective attachments 14,16. An exemplary material for the second dielectric materials 60,62 is a polyimide material, or a high dielectric ceramic material.

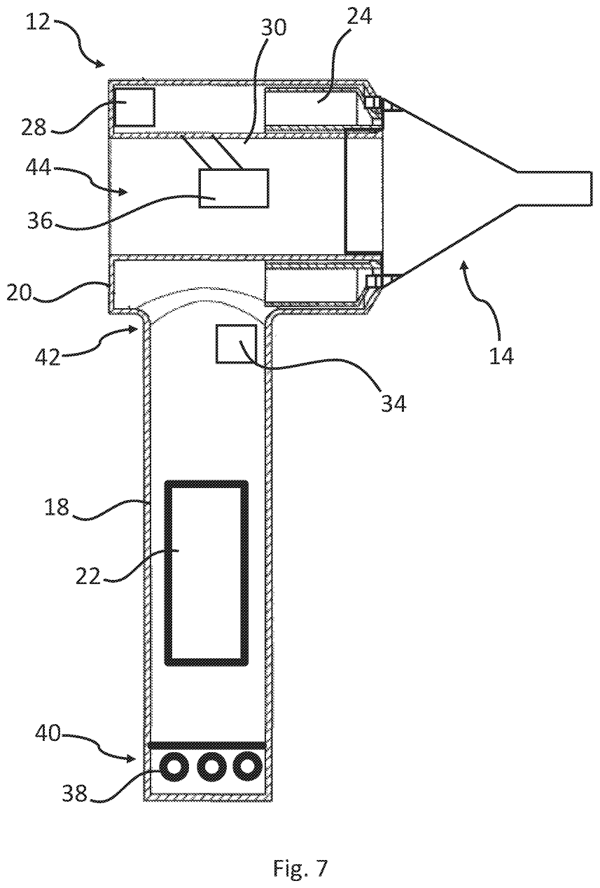

In use, one of the attachments 14,16 is attached to the head portion 20 of the main unit 12, with such a configuration illustrated schematically with the concentrator attachment 14 in FIG. 7. The control module 28 can determine which of the attachments 14, 16 is attached to the main unit 12, and can control the appliance 10 accordingly. In particular, the capacitance sensor 34, the plurality of first electrodes 30, and the second electrodes 56,58, can be utilised to determine which of the attachments 14, 16 is attached to the main unit 12.

As each second electrode 56,58 has a different arcuate extent, each second electrode 56,58 overlaps a different number of the plurality of first electrodes 30 when the respective attachment 14, 16 is attached to the main unit, for example with the second electrodes 56,58 overlapping subsets of the plurality of first electrodes of differing cardinalities. This is illustrated schematically in FIG. 6, where the second electrode 56 of the concentrator attachment 14 overlaps nine of the plurality of first electrodes 30, and the second electrode 58 of the diffuser attachment 16 overlaps two of the plurality of first electrodes 30. The capacitance sensor 34 therefore has a change in capacitance reading on different numbers of its twelve channels depending on which of the attachments 14,16 is attached to the main unit 12, and the control module 28 can then determine which of the attachments 14,16 is attached to the main unit 12 based on the number of channels on which the capacitance sensor 34 has a reading. The control module 28 then uses this determination to control the flow rate and/or the temperature of the airflow, as described further below.

The TOF sensor 36 is used to sense the proximity of a user's head or other object to the appliance 10. In the present example, the control module 28 analyses the distance data output by the TOF sensor 36 and from this analysis determines the proximity of the head of a user. In other examples, the TOF sensor 36 itself, rather than the control module 28, may analyse the distance data and output data indicative the proximity of a user's head. In each of these examples, the control module 55 nevertheless determines the proximity of the user's head based on the data received from the TOF sensor 36. The control module 28 then uses this determination to control the flow rate and/or the temperature of the airflow.

As indicated above, the control module 28 controls the airflow generator 22 and the heater 24 in response to inputs from the capacitance sensor 34 and the time-of-flight sensor 36. As a result, better drying and/or styling results may be achieved. For example, different attachments may deliver better drying or styling results when using different flow rates and/or temperatures. The diffuser attachment 16, for example, is likely to deliver better results when the airflow has a lower flow rate. By employing a lower flow rate, the hair is moved less by the airflow and thus curls may be better defined. By contrast, the concentrator attachment 14 is likely to deliver better results when the airflow has a higher flow rate. In another example, if the head of the user is too close to the appliance, a high flow rate may move the hair excessively resulting in unsatisfactory styling results and/or a high temperature may over-dry or damage the hair. Accordingly, by controlling the flow rate and/or the temperature of the airflow based on which attachment 14, 16, if any, is attached and/or the proximity of the head of the user, better styling results may be achieved.

The control module 28 may store a plurality of different flow and temperature settings, and the control module 28 may select one of the plurality of settings based on which of the attachments 14,16 is attached to the main unit. For example, the control module 28 may store a default flow and temperature setting for each of the attachments 14,16. Additionally, or alternatively, the control module 28 may store the flow and temperature setting selected by a user when last using a particular attachment 14,16.

In such a manner, appropriate flow and/or temperature settings can be determined for a particular attachment 14,16 and/or for a particular distance at which a user's head is located relative to the appliance. Use of the capacitance sensor 34 may provide an attachment recognition system absent the need for any electrical contacts or mechanical switches, which may require precise alignment and/or movable parts which could be prone to failure.

Furthermore, employing the capacitance sensor 34 to determine which of the plurality of attachments 14, 16 is attached to the main unit 12 may provide greater flexibility in choice for further sensing mechanisms that detect other features, for example such as a property of an object external to the appliance 10, when compared to an arrangement that utilises an optical sensing method for determining which attachment 14, 16 is attached to the main unit 12. In particular, use of the capacitance sensor 34 may facilitate use of the TOF sensor 36 by minimising a risk of interference with the emissions of the TOF sensor 36.

Given the spacing between electrodes of the plurality of first electrodes 30, and the arcuate extent of the second electrodes 56,58, it will be appreciated that each second electrode 56,58 may overlap a different number of the plurality of first electrodes 30 depending on a rotational orientation of the respective attachment 14,16 to the main unit 12. For example, the second electrode 56 of the concentrator attachment 14 may either overlap eight or nine of the plurality of first electrodes 30 depending on rotational orientation of the concentrator attachment 14 to the main unit 12. Similarly, the second electrode 58 of the diffuser attachment 16 may either overlap two or three of the plurality of first electrodes 30 depending on rotational orientation of the concentrator attachment 14 to the main unit 12.

This is taken into account by the control module 28, for example with ranges of number of the plurality of first electrodes 30 that provide a change in capacitive response associated with each attachment 14,16. It will be appreciated that the capacitance sensor 34 is capable of detecting a greater number of attachments than just two attachments, in view of the twelve-channel nature and corresponding twelve first electrodes 30, and indeed the capacitance sensor 34, when taking account of variation in rotational orientation, can identify six different attachments using the twelve channels.

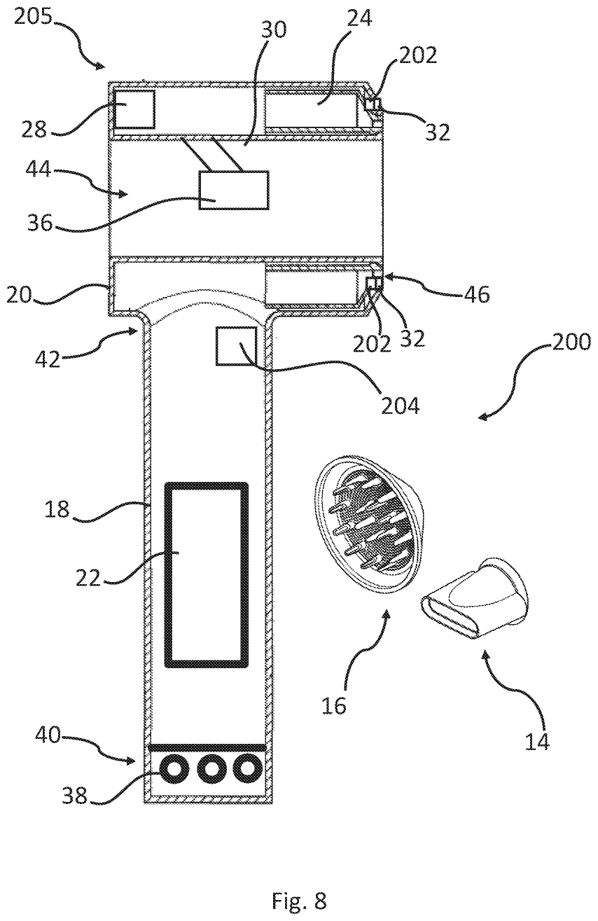

A second embodiment of an appliance 200, in the form of a haircare appliance, is illustrated schematically in FIG. 8, where like reference numerals are used for sake of clarity.

The second embodiment of the appliance 200 differs from the first embodiment of the appliance 10 in the form of the first electrode 202 and the capacitance sensor 204, and hence the form of the main unit 205.

The first electrode 202 is a single annular electrode located within the head portion 20 such that the first electrode 202 extends annularly about the air outlet 46. The first electrode 202 has a fixed cross-sectional area, and is formed of an appropriate conductive material such as copper.

The capacitance sensor 204 comprises a single-channel capacitance sensor, and is located within the handle portion 18 at the second end 42. The capacitance sensor 204 is electrically connected to the first electrode 202 by electrical cabling, which is not shown for sake of clarity.

The attachments 14,16 are the same as those of the first embodiment of the appliance 10, and is formed of an optically transparent material, yet also comprises a respective second electrode 56,58 and a respective second dielectric material 60,62.

In use, one of the attachments 14,16 is attached to the head portion 20 of the main unit 205, in a similar manner to that described in relation to the first embodiment 10 of the appliance described above. The control module 28 can determine which of the attachments 14, 16 is attached to the main unit 205, and can control the appliance 10 accordingly. In particular, the capacitance sensor 204, the first electrode 202, and the second electrodes 56,58, can be utilised to determine which of the attachments 14, 16 is attached to the main unit 205.

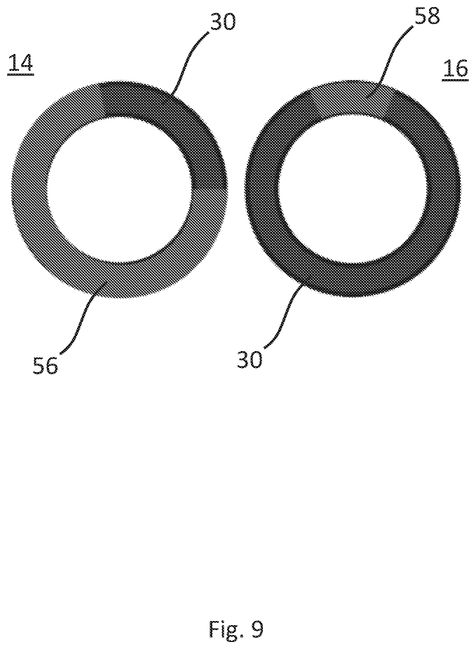

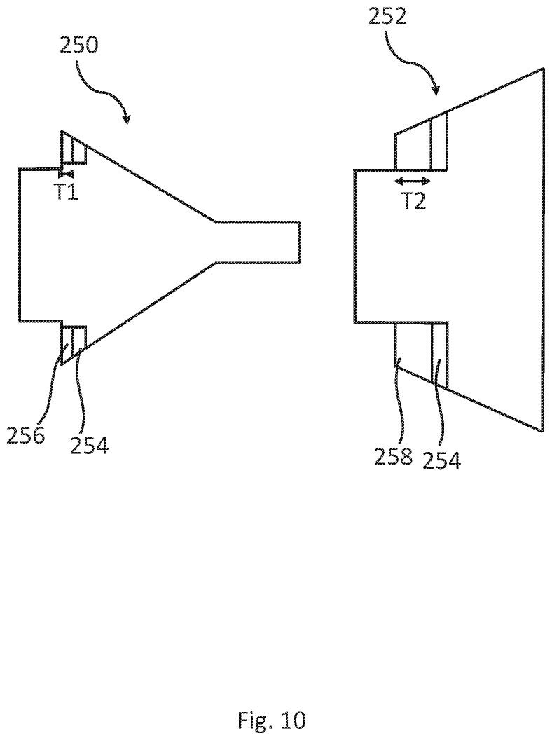

As each second electrode 56,58 has a different arcuate extent, e.g. a different cross-sectional area, each second electrode 56,58 overlaps the first electrode 202 to a different degree when the respective attachment 14, 16 is attached to the main unit 205. This is illustrated schematically in FIG. 9, where the second electrode 56 of the concentrator attachment 14 overlaps the first electrode 202 to a greater degree than the second electrode 58 of the diffuser attachment 16. The capacitance sensor 204 therefore has a change in capacitance reading which is different depending on which of the attachments 14,16 is attached to the main unit 205, as a result of the difference in cross-sectional area of the second electrodes 56,58 of the attachments 14,16. For example, a relatively large cross-sectional area of second electrode, absent a variation in distance between the first and second electrodes, will lead to a different capacitance reading compared to a relatively small cross-sectional area of second electrode.

The control module 28 can then determine which of the attachments 14,16 is attached to the main unit 205 based on the capacitance value measured by the capacitance sensor 204, for example by appropriate comparison to a set of pre-determined discrete capacitance values or ranges. The control module 28 then uses this determination to control the flow rate and/or the temperature of the airflow, as described above.

Variations in thickness of the second dielectric materials 60,62 of the first 14 and second 16 attachments is also envisaged, either as an alternative to, or in addition to, attachment identification utilising second electrodes of differing cross-sectional area. Exemplary attachments 250,252 in the form of concentrator 250 and diffuser 252 attachments in which the dielectric thickness varies are illustrated in FIG. 10, for use with the main unit 205 of the second embodiment of the appliance 200. Each attachment 250,252 has an annular second electrode 254, and a respective second dielectric layer 256,258. The dielectric layers 256,258 are formed of polyimide, or any other type of high dielectric material such as plastic or ceramic, and overlie the respective annular second electrodes 254. The second dielectric layer 256 of the concentrator attachment 250 has a first thickness T1, whilst the second dielectric layer 258 of the diffuser attachment 252 has a second thickness T2 greater than the first thickness T1.

In use, one of the attachments 250,252 is attached to the head portion 20 of the main unit 205, in a similar manner to that described in relation to the second embodiment 200 of the appliance described above. The control module 28 can determine which of the attachments 250,252 is attached to the main unit 205, and can control the appliance 10 accordingly. In particular, the capacitance sensor 204, the first electrode 202, the second electrodes 254, and the respective second dielectric layers 256,258, can be utilised to determine which of the attachments 14, 16 is attached to the main unit 12.

As each second dielectric layer 256,258 has a different thickness, the capacitance sensor 204 has a change in capacitance reading which is different depending on which of the attachments 250,252 is attached to the main unit 205. For example, a relatively thick dielectric layer, absent a variation in cross-sectional area between the first and second electrodes, will lead to a different capacitance reading compared to a relatively thin dielectric layer.

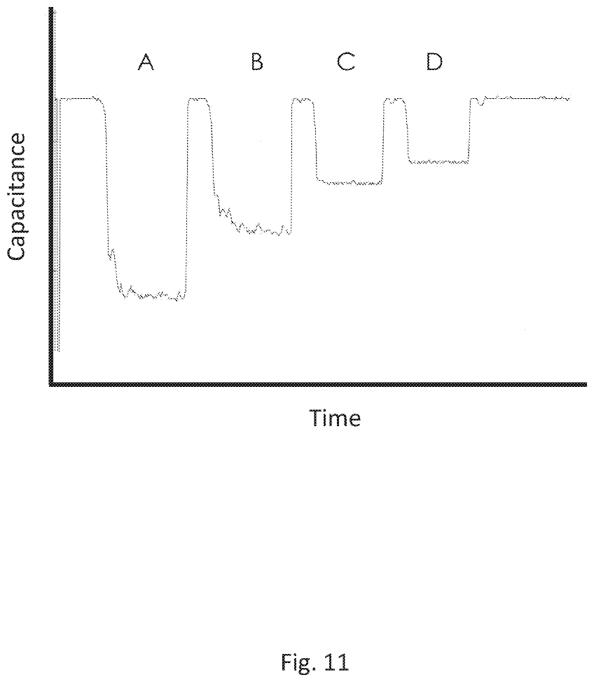

The control module 28 can then determine which of the attachments 250,252 is attached to the main unit 205 based on the capacitance value measured by the capacitance sensor 204, for example by appropriate comparison to a set of pre-determined discrete capacitance values or ranges. The control module 28 then uses this determination to control the flow rate and/or the temperature of the airflow, as described above. Illustrative capacitance readings for four attachments A-D that have varying thicknesses of dielectric material are shown in FIG. 11.

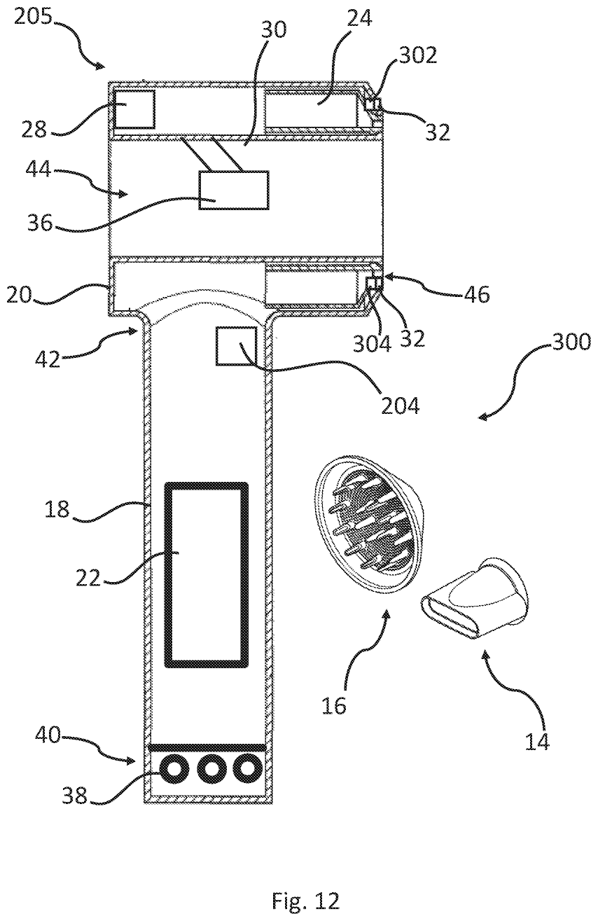

A third embodiment of an appliance 300, in the form of a haircare appliance, is illustrated schematically in FIG. 12, where like reference numerals are used for sake of clarity.

The third embodiment of the appliance 300 differs from the second embodiment of the appliance 200 in that a drive electrode 302 and a receiver electrode 304 replace the first electrode 202. The drive electrode 302 and the receiver electrode 304 are spaced apart about a periphery of the air outlet 46. In use, the drive electrode 302 is driven such that an electromagnetic or electric field is created. When an attachment, such as the concentrator attachment 14 and the diffuser attachment 16 having second electrodes 56,58 of differing arcuate extents, is attached to the main unit 205, the second electrodes interfere with the electromagnetic field generated by the drive electrode. Such interference has an impact on the capacitance response measured at the capacitance sensor 204, with the difference in the second electrodes 56,58 meaning that each attachment 14, 16 provides a different capacitance response when attached to the main unit 205. This capacitance interaction may be referred to as mutual capacitance sensing.

The control module 28 can then determine which of the attachments 14,16 is attached to the main unit 205 based on the capacitance value measured by the capacitance sensor 204, for example by appropriate comparison to a set of pre-determined discrete capacitance values or ranges. The control module 28 then uses this determination to control the flow rate and/or the temperature of the airflow, as described further above.

In the examples described above, the appliances 10,200,300 are haircare appliances that emit an airflow for drying and styling hair. The control module 28 of the appliances 10,200,300 then controls the flow rate and/or the temperature of the airflow based on data output by the capacitance sensor. In particular, the flow rate and/or the temperature may be controlled according to which attachment, if any, is in use. Additionally, the flow rate and/or the temperature may be controlled according to the proximity of a user's head to the appliances 10,200,300 as determined by the TOF sensor 36.

The principles described above may be used with other types of appliance having a plurality of different attachments. For example, the appliance may be a vacuum cleaner having a main unit to which one of a plurality of different attachments may be attached. The main unit may comprise an airflow generator that generates suction at each of the attachments. The attachments may comprise a first suction nozzle for use on floors, and a second suction nozzle for use on upholstery. When used on floors, a higher suction may be beneficial to draw in more of the dirt. However, when used on upholstery, a higher suction may cause the upholstery to be sucked into and block the suction nozzle. Accordingly, better results may be achieved on upholstery with a lower suction. The main unit may therefore comprise a capacitance sensor that senses which of the attachments is attached, and a control module that controls the suction of the airflow generator based on the data output by the capacitance sensor. In another example, the appliance may be a power tool or the like that comprises an electric motor for driving different attachments. A capacitance sensor may sense which of the attachments is attached, and a control module may control the speed and/or torque of the electric motor based on the data output by the capacitance sensor. Accordingly, in a more general sense, the appliance may be said to comprise a main unit to which one of a plurality of attachments is attachable. The appliance comprises a capacitance sensor and a control module that is operable to determine which of the plurality of attachments is attached to the main unit based on data output by the capacitance sensor. The control module may then control an electrical component (e.g., an electric motor, an airflow generator or a heater) in response to the determination.

Whilst particular examples and embodiments have thus far been described, it should be understood that these are illustrative only and that various modifications may be made without departing from the scope of the invention as defined by the claims.

1-25. (canceled)

26. An appliance comprising:
a main unit to which one of a plurality of attachments is attachable;
a capacitance sensor; and
a control module operable to determine which of the plurality of attachments is attached to the main unit based on data output by the capacitance sensor.

27. An appliance as claimed in claim 26, wherein the appliance comprises an electric component and the control module is operable to control the electric component in response to the determination, wherein the electric component is an electric motor or a heater, and the control module is operable to control a speed of the electric motor or a temperature of the heater in response to the determination.

28. An appliance as claimed in claim 26, wherein the appliance comprises an airflow generator for drawing an airflow through the appliance, and the control module is operable to control a characteristic of the airflow in response to the determination.

29. An appliance as claimed in claim 28, wherein the control module is operable to control one or more of a flow rate and a temperature of the airflow.

30. An appliance as claimed in claim 26, wherein the appliance is a haircare appliance comprising a plurality of flow and heat settings, and the control module is operable to select one of the settings based on the determination.

31. An appliance as claimed in claim 26, wherein the appliance comprises the plurality of attachments, and each of the plurality of attachments is configured to cause a different capacitive response at the capacitance sensor.

32. An appliance as claimed in claim 31, wherein the main unit comprises a first electrode, and each of the plurality of attachments comprises a respective second electrode, each second electrode different to each other second electrode.

33. An appliance as claimed in claim 32, wherein each second electrode comprises a different cross-sectional area to each other second electrode.

34. An appliance as claimed in claim 32, wherein a first one of the plurality of attachments comprises a first number of second electrodes, and a second one of the plurality of attachments comprises a second number of second electrodes different to the first number of second electrodes.

35. An appliance as claimed in claim 32, wherein the first electrode comprises a plurality of first electrodes, and the data output by the capacitance sensor is indicative of a number of the plurality of first electrodes that overlap with the second electrode of the respective one of the plurality of attachments when attached to the main unit.

36. An appliance as claimed in claim 35, wherein the plurality of first electrodes are arranged in a substantially annular array, each second electrode is arcuate in form, and the plurality of first electrodes and each second electrode are configured such that the data output by the capacitance sensor is dependent on a rotational orientation of the attachment to the main unit.

37. An appliance as claimed in claim 35, wherein the plurality of first electrodes are arranged in a substantially annular array, each second electrode is arcuate in form, and the plurality of first electrodes and each second electrode are configured such that the data output by the capacitance sensor is constant for a given attachment irrespective of rotational orientation of the attachment to the main unit.

38. An appliance as claimed in claim 31, wherein the main unit comprises a first electrode, and a first dielectric portion overlying the first electrode, each of the plurality of attachments comprises a respective second electrode, and a respective second dielectric portion overlying the second electrode, and each second dielectric portion is different to each other second dielectric portion.

39. An appliance as claimed in claim 38, wherein each second dielectric portion comprises a different thickness to each other second dielectric portion.

40. An appliance as claimed in claim 38, wherein the first dielectric portion is unevenly distributed across the first electrode.

41. An appliance as claimed in claim 31, wherein each of the plurality of attachments comprises a respective second electrode, and a respective second dielectric portion overlying the second electrode, and each second dielectric portion is different to each other second dielectric portion.

42. An appliance as claimed in claim 31, wherein the main unit comprises a drive electrode and a receiver electrode, and each of the plurality of attachments comprises a respective second electrode, each second electrode different to each other second electrode.

43. An appliance as claimed in claim 26, wherein the appliance comprises an emitter configured to emit optical radiation, an optical sensor configured to receive reflected optical radiation from an object external to the appliance, and a further control module configured to determine a property of the object based on further data output by the optical sensor.

44. An attachment for a haircare appliance, the attachment comprising an interface portion configured to interface with a main unit of the haircare appliance, the interface portion comprising an electrode layer wherein the electrode layer is exposed at the interface portion.

45. An attachment as claimed in claim 44, wherein the interface portion comprises a dielectric layer overlying the electrode layer such that the dielectric layer is exposed at the interface portion.
